(19) United States
(12) Patent Application Publication
(10) Pub. No.: US 2002/0170040 A1
(43) Pub. Date: Nov. 14, 2002

(54) Computer implemented user relationship maintenance technique for target software application

(75) Inventor: Amir Idan, Hed Hasharon (IL)

Correspondence Address: LADAS & PARRY, 26 WEST 61ST STREET, NEW YORK, NY, 10023, US

(73) Assignee: APPOWER SYSTEMS LTD.

(21) Appl. No.: 09/785,954

(22) Filed: Feb. 16, 2001

(51) Int. Cl. G06F 9/45

(52) U.S. Cl. 717/141; 713/182

(57) ABSTRACT

An application portal management technique is implemented in a Internet-adapted user relationship management product that provides intelligent direct and community messaging service channels. Content provided across these channels is automatically directed into soft-ware applications. The services which are thus made available are useful in marketing automation, application support and maintenance, user-to-user collaboration, and they provide a useful sales and marketing facility for the software publisher. The product also facilitates the development and ongoing activities of end-user communities.

### REFERENCE TO COMPUTER PROGRAM LISTING APPENDIX

Computer program listing appendices are submitted herewith on one compact disc and one duplicate compact disc. The total number of compact discs including duplicates is two. The files on the compact disc are ASCII text files in which the characters are displayed as their corresponding values in hexadecimal format. Their names, dates of creation, directory locations, and sizes in bytes are:

1. Directory appndx-a containing file 37841A.HEX (Appendix A) of Jan. 10, 2001 and of length 5,605 bytes.

2. Directory appndx-b containing file 37841B.HEX (Appendix B) of Jan. 10, 2001 and of length 15,517 bytes.

3. Directory appndx-c containing file 37841C.HEX (Appendix C) of Jan. 10, 2001 and of length 181,012 bytes.

4. Directory appndx-d containing file 37841D.HEX (Appendix D) of Jan. 10, 2001 and of length 57,171 bytes.

The files are referred to herein as appendices A-D respectively. The material on the compact discs is incorporated by reference herein.

### BACKGROUND OF THE INVENTION

1. Field of the Invention

This invention relates to electronic end-user relationship management. More particularly this invention relates to the management of relationships between software vendors and the end-users of the software and to the development of end-user communities through the use of an intelligent computer implemented messaging system.

2. Description of the Related Art

As end-users of software have become more numerous and geographically dispersed, efficient end-user management has become a matter of concern to vendors. The ability to reach each and every end-user using the software, provide relevant information and software updates, quickly and efficiently, both in terms of improved functionality and bug fixes, is an issue that can affect the economic success of both the vendors and the end-users. Currently software vendors commonly deal with the issue by providing the information and downloadable files on their servers (web-sites) accessible via the internet. While this solution is usable, there are a number of drawbacks. In some cases the end-user is required to connect to the internet, and actually locate and access the vendor's web page, select the appropriate download, and then undertake an installation procedure. Restarting the computer system may be required. With this system, the vendor has limited ability to notify the end-user community of the existence of updates. This is not a proactive approach, and end-users rarely spend time on the vendor's web sites. The vendor's recourse is simply to advise the user community to check its web site “frequently”. End-users vary widely in their desire or ability to interrupt their workflow to comply with the vendor's advice. As a result, the provision of updates and information exchange to end-users is inconsistent and unreliable.

Some vendors have attempted to improve on the above noted technique by providing a schedule of prompts to the end-users, or in some cases by establishing a resident program that automatically accesses the vendor's site and checks for updates. While these techniques work, the communication is limited in scope, with little opportunity for the end-users to easily interact with the vendor or with one another.

Push technology has been proposed as an efficient mechanism for communicating content to end-users quickly and easily. However, there are many issues and disadvantages associated with push technology, which have led to its current disfavor in the market. Push technology consumes large amounts of precious bandwidth. Proprietary push products require a substantial programming effort to implement. Even the best push technology products require the user to leave his working environment and “look up” the information being sent to him. Push technology provides no inherent way for marketers and other content providers to measure recipient response and reaction to a message. Lastly, push technology provides no inherent way for users to create communities and proactively collaborate with one another.

Recently new products have been introduced that propose to turn conventional electronic mail into information channels. These products install a dynamic linked library (DLL) or similar component onto the user's desktop. When the user checks his E-mail, the current E-mail contents are dynamically refreshed with new content. While this approach has initial natural appeal, it flies in the face of current usage practices. In practice most people tend to read and delete their e-mail. Users worldwide are constantly struggling to clean out overburdened mailboxes. Furthermore, filed conventional e-mail tends to be unread mail, at least until the user makes a conscious effort to finally delete a whole raft of ancient messages.

Another approach involves the vendor's simply asking end-users to provide their email addresses, so that vendors will be able to communicate with users via standard email. This approach is problematic as vendors never have access to all end-user email addresses, and email addresses which have been provided become obsolete after an average of 5 months.

### SUMMARY OF THE INVENTION

It is therefore a primary object of some aspects of the present invention to improve communication between software vendors and end-users of the software.

It is yet another object of some aspects of the present invention to facilitate the development of end-user communities in respect of particular software applications.

These and other objects of the present invention are attained by an application portal management technique. This technique is implemented in a Internet-adapted user relationship management product that provides intelligent direct and community messaging service channels. Content provided across these channels is automatically directed into software applications. The services which are thus made available are useful in application support and maintenance, and they provide a useful sales and marketing facility for the software publisher. The product also facilitates the development and ongoing activities of end-user communities.

Founded on the premise that the software publisher's most valuable asset is the “prime real estate”—the application space established on the user's desktop, the inventive technique redefines this space by enabling users and software publishers to communicate, collaborate, and share information while users work within the application. The application space is no longer a static environment for accomplishing a specific task, but becomes a dynamic, web-enabled information portal, giving end-users valuable, time saving features while simultaneously offering publishers crucial insight into the needs of their customers. The technique according to the invention effectively deals with the meteoric rise in electronic marketing, in which product marketers face significant challenges in cutting through the “noise”—the overwhelming amount of material reaching customers via fax and email, each day.

The inventive techniques neutralizes the noise with an approach to informing, empowering, and communicating with users that involves working through the application space, that is the working environment created by the software application, where users spend most of their time. This approach, which is believed by the inventors to be novel, offers software marketers and end-users immediate benefits not available through any other venue. Using this technique, software publishers can reach their users from within the application, with a combination of focused electronic information messaging, user communities, and an intelligent pre-screened search engine, thus providing a complete user relationship management solution.

The invention benefits both software users and software publishers. It improves users' experiences with the application and increases user loyalty and product knowledge. Ultimately the target audience is present, focused, and interested. And at the same time, it improves software publisher support and strengthens brand identity.

Further advantages of the invention include information messaging, particularly electronic direct marketing (EDM), community building and managing, and intelligent search, all of which are conducted from within the application space. Using the invention, software publishers can generate more revenue through repeat sales, upgrade purchases, new sales, and cross-product sales. The advantages for software publishers derive from automatic market segmentation tools that are able to send targeted messages and receive precise immediate feedback about which messages have been read as well as the opportunity to view the users' responses to those messages.

It will be appreciated by those skilled in the art that communicating with users through the application space leads to exponentially higher response rates, a better return on investment, and more informed vendors and users.

The invention provides a software plug in, which converts any Windows™ compatible desktop software into an application portal engine. The software publisher manages the system through a server layer hosted by a server farm which communicates with the software plug-in via the Internet, or in some embodiments, a private data network.

The invention provides a combination of integrated techniques to achieve its purposes. Included is a method for determining the internal structure of a target software application, and for attaching an agent to the application in runtime, without modifying the target application's object code, and without requiring the software vendor to devote R&D time to modify his application. The invention further provides a method for determining the relevant resources, such as newsgroups, knowledge bases, and web-sites for target software applications, and provides the end-user with a one-click interface for interaction with these resources, while the end-user continues to operate from within the environment of the target application.

In some preferred embodiments there is included a method for establishing a communications channel between a first end-user and other end-users who are both currently using the same software application, so that information can be exchanged therebetween.

In some preferred embodiments of the invention a one-to-one relationship and communication channel are established between a software vendor and a plurality of its end-users, without requiring the software vendor to identify the end-users.

In some preferred embodiments usage details of a community of end-users of a particular software application can be automatically determined by the vendor, without requiring that the end-users identify themselves. Provision is made for obtaining permission of the end-users to collect such details.

The invention further provides for collection of statistical information concerning an end-user community, and for the determination of end-user behavior with respect to a particular software application.

It is an advantage of some aspects of the invention that allows a software publisher to directly reach all end-users, not simply purchasers, at any time, in any place via the application desktop. E-mail clutter is effectively eliminated, and highly focused messages are provided by the vendor to the end-user.

It is a further advantage of some aspects of the invention that community collaboration is allowed within the software application's environment, without recourse to external mailer programs.

It is still another advantage of some aspects of the invention that security of messaging traffic is enhanced, as the vendor controls both the process and content of sending out information to end-users.

The invention provides a computer software product which causes the computer to perform the steps of determining a structure of a target software application, and, responsive structure, attaching an agent to the target software application at runtime, without modifying the code or the structure of the target application. A first connection is established between the agent and a server via a data network. A first message is received from the server, and a notification of the first message is presented by the agent to a user in the environment of the target software application.

In one aspect of the invention, a second connection is established between the agent and a second agent in a second computer via the data network. A second message is communicated between the agent and the second agent and a notification of the second message is presented by the agent to the user in the environment of the target software application.

In another aspect of the invention, the agent is a plug-in of the target software application.

In yet another aspect of the invention, a second computer-readable medium is installed in a server to cause the server to transmit the first message to the agent. The server optionally authenticates the identity of the computer on which the agent resides.

In still another aspect of the invention, the server allows controlled access by a third computer, wherein the first message originates in the third computer.

In another aspect of the invention the server receives information from the agent via the data network indicative of an response of the user to the first message. The server may store a record of the user response. Optionally the server maintains a data base of users of the target software application.

The invention provides a computer implemented method of communication, comprising the steps of establishing a connection between a user interface of a target software application that executes on a first computer and a second computer across a data network, transmitting a message from the second computer to the first computer via the connection, and notifying a user of the target software application of the message on the user interface.

According to another aspect of the invention, the connection is established by identifying a structure of the target software application.

According to another aspect of the invention, a software agent is interposed in the connection, and may execute on the first computer.

According to yet another aspect of the invention, the software agent is a plug-in of the target software application.

According to another aspect of the invention, the second computer is a server.

According to a further aspect of the invention, the second computer is an end-user computer.

The invention provides a computer having a target software application resident therein, a software agent that attaches to the target software application and controls a user interface of the target software application. The computer is attached to a data network, and the software agent receives a first message that is transmitted from a second computer via the network. A notice of the first message is displayed on the user interface of the target software application.

According to an aspect of the invention, the software agent is a plug-in of the target software application.

According to another aspect of the invention, the software agent accepts the first message according to a policy of a user of the target software application.

### BRIEF DESCRIPTION OF THE DRAWINGS

For a better understanding of these and other objects of the present invention, reference is made to the detailed description of the invention, by way of example, which is to be read in conjunction with the following drawings, wherein:

FIG. 1 is a high level diagram of the architecture of a messaging system according to a preferred embodiment of the invention;

FIG. 2 is a diagram illustrating the architecture of the messaging system shown in FIG. 1 in further detail;

FIG. 3 is a diagram similar to FIG. 2 illustrating the architecture of an alternate embodiment of the invention;

FIG. 4 is a block diagram of a messaging engine according to the invention;

FIGS. 5A and 5B, referred to collectively herein as FIG. 5, are flow diagrams illustrating the messaging process used in a preferred embodiment of the invention;

FIG. 6 is a flow diagram illustrating the procedure followed by a client in the messaging process according to the invention; and

FIG. 7 is a high level diagram illustrating the architecture of a messaging system according to an alternate embodiment of the invention.

### DESCRIPTION OF THE PREFERRED EMBODIMENT

In the following description, numerous specific details are set forth in order to provide a thorough understanding of the present invention. It will be apparent however, to one skilled in the art that the present invention may be practiced without these specific details. In other instances well known circuits, control logic, and the details of computer program instructions for conventional algorithms and processes have not been shown in detail in order not to unnecessarily obscure the present invention.

Definitions.

The following definitions and usages apply to this disclosure.

Application space: The “virtual” communications and community channel created by the technology disclosed herein.

Application portal: Any program supported by software according to the invention. An application portal integrates messaging, communities, and search capabilities within the application space.

Categories: Different topics provided by the vendor, that the end-user can choose to access, enabling the end-user to decide which information he would like to receive.

CRM: Customer relationship management

ECRM: Electronic customer relationship management. A superset of CRM.

URM: User Relationship Management.

Magnetism: This term refers to the ability of an application to retain a user's attention and to increase their interaction with a product.

Messaging community: A community built upon a mail-based structure. According to the invention communities can be started by a vendor or by an application's end-users.

Multi-Channel EDM: Refers to the ability of application spaces to be opened to complementary marketing efforts from other publishers.

User relationship management (URM): A component of ECRM. User relationship management is designed to meet the special requirements and needs of software publishers and vendors. URM products transform applications into application portals, integrating direct marketing, communities, and search into the application space.

Messages: A collection of rich text, pictures, sound, voice annotations and multi-media. Messages created in the Messages/Templates tab are attached to one or more campaigns and can be sent as part of a campaign in a pre-scheduled time and date. Categories or subject based sections can be linked to messages to give messages specifically defined parameters.

Segments: Segments are user groups that are defined by a dynamic rule based mechanism. For example, a marketing person can arrange and organize a group of users by geographical location, application versions, languages spoken and many other predefined parameters.

Campaigns: Campaigns are a series of one or more messages that can be sent to a multiple range of segments or user groups defined by a dynamic rule based mechanism. After the campaign's messages have been sent, statistical reports can be produced on the campaign and its results.

Links: Links allow software vendors to choose which URL addresses they feel are significant for their users to view. The links that are chosen by the software vendor will appear and be automatically updated when changed in the “Links” feature on the client based application. This feature gives users easy and quick access to pertinent information predefined by a software vendor. A client based links feature allows users to quickly and easily access pertinent information supplied by the software vendor. The software vendor predefines the links that are significant to the user. When a link is depressed, a pop-up browser appears linking the user to the related topic.

Golden Circles: Golden Circles are in essence ‘Forums’. From a drop down menu shown above, users can enter a circle and communicate with a community of end-users with similar interests from within the application.

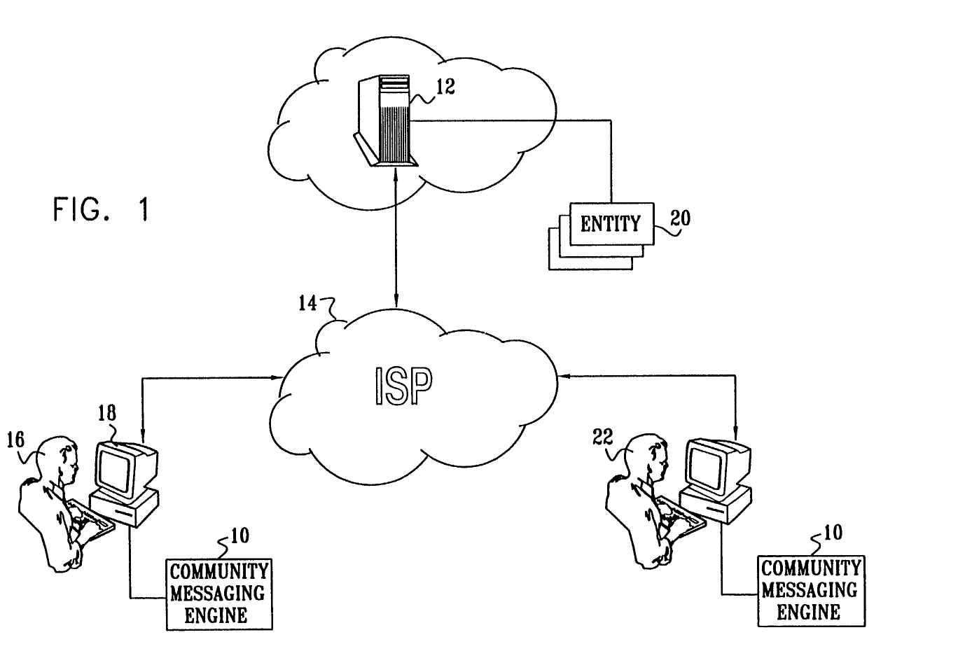

Turning now to the drawings, and to FIG. 1 thereof, in a preferred embodiment of the invention, intelligent messaging and channels are directly integrated into any supported application running under Windows™ 9X, Windows™ NT, or Windows™ 2000. The invention can be realized in other operating systems as well, using programming techniques known to those skilled in the art. There are two principal components, a client-based community messaging engine 10 and a server based manager 12. The latter functions as a message, campaign, and community manager. While the single server based manager 12 is shown for clarity, it is contemplated that the messaging engine 10 can be receptive to communications from a plurality of server based managers at any given time. The messaging engine 10 and the server based manager 12 are connected via a data network, typically the Internet, optionally via an internet service provider 14. Integration occurs when a user 16 either downloads the messaging engine 10 into its computer system and installs it or the user 16 downloads a software product that includes the messaging engine 10. The messaging engine 10 may be bundled with any supported software application. After installation, the supported application displays an icon, such as an “I” bar icon in a corner of the application's screen display, indicating that the messaging engine 10 is functional. In some embodiments, the icon can be implemented as a transient prompt for the user or omitted entirely. At this juncture, the user 16 can receive messages within the application's environment, independent of any mailer program or electronic mail application that is installed in the client computer 18. The user 16 is able to configure the messaging engine 10 in such matters as time and priority of notification of messages that are received from the server based manager 12, subscription to different message channels, and responses to various types of messages. Messages can contain rich text, pictures, sound and voice annotations, as well as attachments prescreened by the software publisher.

Preferably the internet is the medium of communication. When the user 16 logs on for any reason, a transparent connection is formed between the server based manager 12 and the applications currently being executed by the client computer 18, uploading new messages and downloading useful information that serve useful purposes, for example market and product development.

Controlled access to the server based manager 12 is provided to an entity 20 desirous of transmitting messages to users, such as the user 16. There may be a plurality of such entities. Typically the entities are software vendors or publishers, but can be other commercial or non-commercial entities as well. Thus a vendor or marketing manager with access to the server based manager 12 may be granted privileges to send messages and content on an ad hoc or scheduled basis to all users of a supported software application having a currently enabled messaging engine 10.

The server based manager 12 is able to monitor the interaction of the user 16 with received messages. Useful information and statistics can thus be derived for the benefit of the entity 20 regarding such matters as the percentage of messages read and reaction of the user 16 to particular messages and campaigns. Software marketers are thus provided with a wide variety of explicit and implicit information about their customers' needs and desires.

In some preferred embodiments, the user 16 is able to communicate directly other users, shown representatively as user 22 or with the entity 20, from within the program. Users can set up “Golden Circles”, i.e., message-based communities of application users with similar interests and specialties. These communities allow users to establish forums, topic categories within the forums, and a community calendar within the forums. The application thus develops added value as a result of the power of community collaboration and support. The result is increased application “stickiness” and magnetism as the application becomes a part of an integrated work and communications environment, and is no longer simply a business tool.

Some preferred embodiments provide the ability to add relevant search within an application. When a user activates this feature within the application, a search engine scans vendor databases, Usenet forums, targeted web sites, and application community databases for information. This further enhances the value of the application, as the users increasingly rely on the search engine to provide information quickly and without the distraction of having to leave the application environment. From the vendor's perspective, vendors will now know what users are searching for, and will be able to provide a better service.

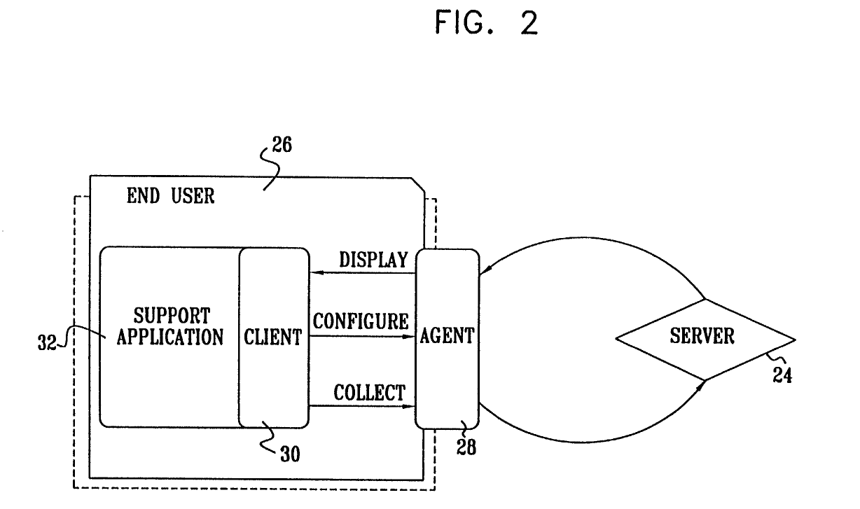

The high level organization of the messaging engine 10 in the client computer 18, and the server based manager 12 is shown in FIG. 2. A server 24 interfaces with the end-user 26 via a software agent 28. Downloaded messages and uploaded information are transmitted via a data network, typically the Internet, between the server 24 and the software agent 28, the software agent 28, corresponding to the messaging engine 10, normally is resident in client 30, which preferably is the computer of the end-user. The client 30 executes a supported application 32, and is able to configure and communicate collected information to the software agent 28.

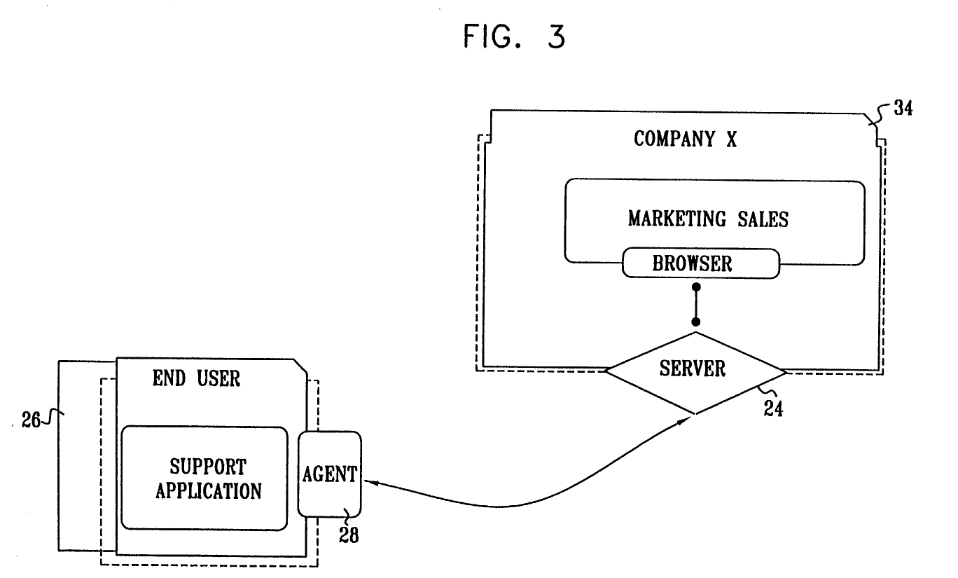

In FIG. 3 the system shown in FIG. 2 has been extended to include a third party 34, which corresponds to entity 20 of FIG. 1, and which can interact with and even control the server 24 via the internet or other data network. The third party 34 is thus enabled to asynchronously deliver information with respect to the application 32 to the end-user 26 and to an unlimited number of other end-users who are executing the application 32 and have established a similar channel with the server 24.

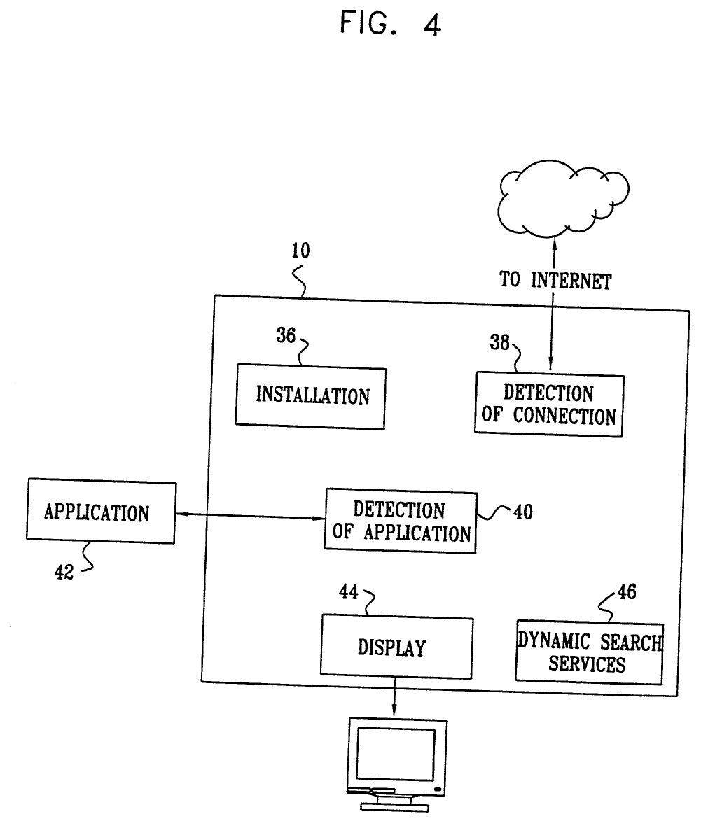

The messaging engine 10 is shown in further detail with reference FIGS. 1 and 4. A first module, installation module 36, is either bundled with the software application or downloaded independently by the user 16. The installation module 36 is installed on the client computer 18. It performs an evaluation of the machine environment of the client computer 18, and then, via an internet connection, downloads all modules that are necessary for system generation.

Once the system has been installed and becomes operational, a second module 38 continually executes a process that detects available Internet connections, and initiates a connection with the server based manager 12. The second module 38 downloads pending data, and uploads data to the server. A third module 40 constantly checks which software applications are currently running on the client computer 18, and attaches as a plug-in to a supported software application 42 in runtime. A fourth module 44 displays received messages from the software vendor. A fifth module 46 provides dynamic search services, and other community services.

Messaging Services.

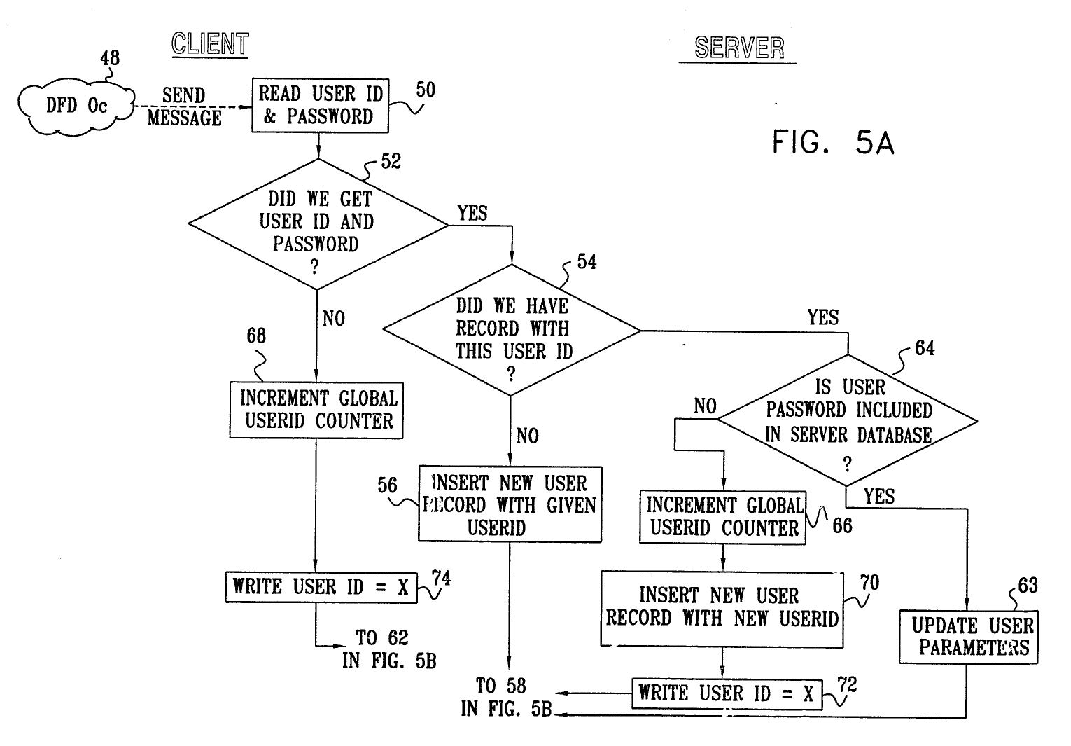

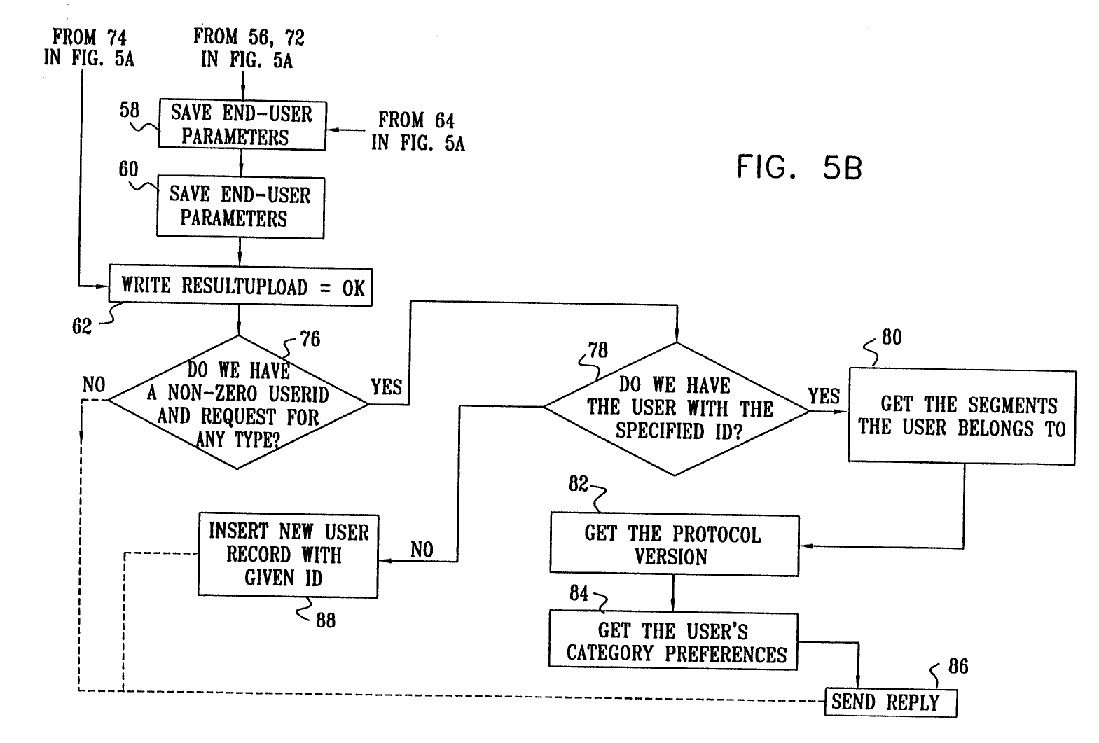

The interaction of the server based manager 12 with the user 16 and the messaging engine 10 is explained in further detail with reference to FIGS. 1 and 5. It is assumed that the messaging engine 10 has been installed in the client computer 18, and that a connection with the internet has been established. Establishment of an internet connection by a computer is well known in the art and will not be further described herein. At step 48 a client, such as the user 16, transmits a message to the server based manager 12. In FIG. 5, this is realized using a client data flow diagram (“DFD Oc”), which charts the flow of data in the application. At step 50 the server based manager 12 reads the user identification and password of the user 16. At decision step 52 a test is made to determine if the user identification and password were received. If the result of this test is affirmative, then control passes to decision step 54, where a further test is made to determine if the user 16 is known to the server based manager 12.

If the result of the test at decision step 54 is negative then at step 56 a new user ID is inserted into the database of the server based manager 12, using the user identification which was given by the user 16. Then, at step 58 end-user parameters needed by the database are read. Control then passes to step 60 where the user parameters are saved to the database of the server based manager 12. Control then passes to step 62, which is described below.

If the result of the test at decision step 54 is positive, then a further test is performed at decision step 64 to determine if the password of the user 16 is found in the user record of the database of the server based manager 12. If the result of the test at decision step 64 is affirmative, then the user 16 has been authenticated, and all that is necessary is to update the end-user parameters at step 63. Control then passes to step 58 which has been described above.

If, however, the test at decision step 64 is negative, then the user 16 has a known user identification, but a different password. It is assumed that this is a new user. At step 66, just as in step 68, as described hereinbelow, a global ID counter maintained in the server based manager 12 is incremented. A new user record is then created in the database of the server based manager 12, using the information received from the user 16 at step 70. An updating entry in the database of the server based manager 12 is then performed at step 72. Control then proceeds to step 58.

If the result of the test at decision step 52 is negative then it is determined that the user 16 is not registered with the server based manager 12. A global ID counter maintained in the server based manager 12 is incremented at step 68, and sent to the user 16. This procedure assures that the new User ID is stored in the client computer 18 prior to updating the database of the server based manager 12. An updating entry in the database of the server based manager 12 is then performed at step 74. Control then passes to step 62, where a table entry is marked in the database of the server based manager 12. The marking of the entry at step 62 constitutes an acceptable upload of the result.

Following completion of step 62, at decision step 76 if the User ID has a value other than zero and there is a request for any type, then decision step 78 is performed to determine if the database contains information about the user having the specified user ID. If the result of the test at decision step 78 is affirmative, then control passes to step 80, where segment information pertaining to the user is retrieved. Next at step 82, the protocol version is obtained, in order to assure communication compatibility between the current server application and the messaging engine 10 (FIG. 1). Then at step 84 the category preferences of the user are obtained from the database. A reply is sent at step 86.

If the test at decision step 76 is negative, control simply proceeds to step 86. If the test at decision step 78 is negative, then a new record with the given user id is inserted at step 88. Control then proceeds to step 86.

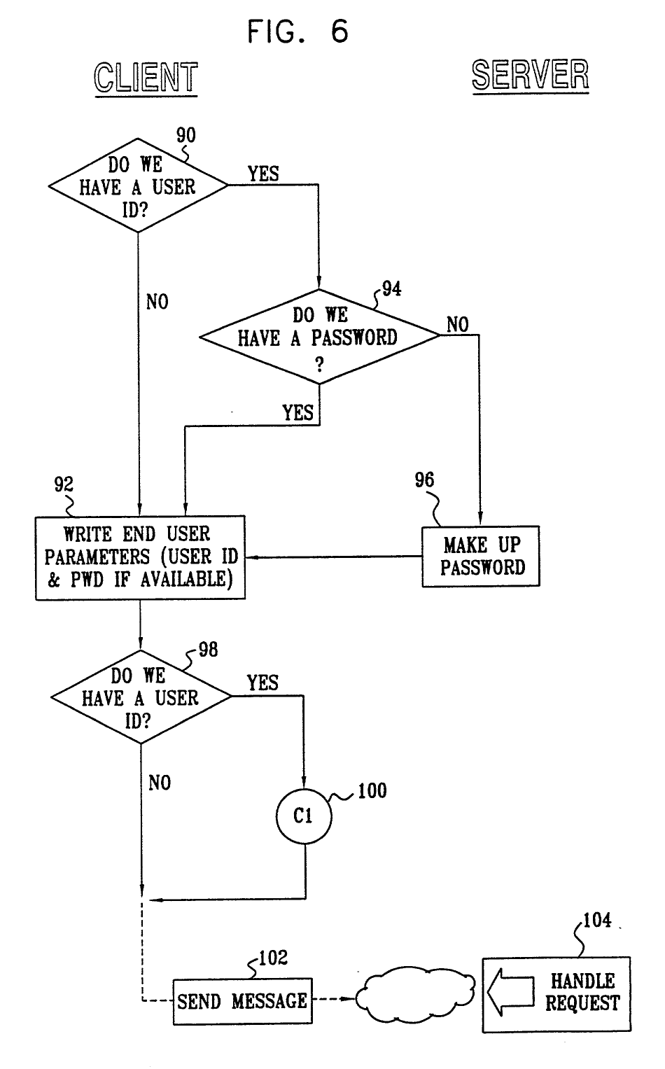

The messaging procedure from the perspective of the user 16 is described with reference to FIG. 6. At decision step 90 the user 16 determines if he has a User ID for the server based manager 12. If the result of this test is negative, then the user 16 is a new user. Available parameters are written and sent to the server based manager 12 at step 92, even though the User ID and password may not be available.

If the result of the test at decision step 90 is affirmative, then at decision step 94 a further test is made to verify that a password is available. If the result of this test is affirmative, then control simply passes to step 92. If the result of the test at decision step 94 is negative, then at this point a User ID has been received from the server based manager 12 at step 68 (FIG. 5), but a password has not yet been created. Until a password is created the database of the server based manager 12 will not create a new record for the user 16. According to the sequence presented in FIG. 6, storage of the User ID is assured prior to creation of a new user record in the database of the server based manager 12. At step 96 a password is created, and control again passes to step 92.

Then, at decision step 98 a further check is made to determine if a user id is available. It may have already been available because the user 16 is known to the server based manager 12, or it may have been received at step 68 (FIG. 5). If the result of the test at decision step 98 is affirmative, then at step 100 the request parameters are written out to the server based manager 12. Otherwise the message is simply sent out at step 102, and the user 16 will be treated by the server based manager 12 as a new user as described above. In either case the message is handled by the server based manager 12 at step 104.

Displaying Messages.

Referring again to FIG. 2, the process of displaying a message begins with the software agent 28, which downloads the relevant messages from the server 24, and stores them locally until the target application is launched.

Once the target application is launched, the Client notifies status-change to the software agent 28, and only then the end-user 26 is notified that a message is pending.

There are two modes of notification that a message is pending. The mode of operation is configured by the end-user 26. In a first mode an envelope icon with the message header is animated on the bottom of the target application, appearing as if the envelope is coming out of the application's main window. Clicking on the envelope opens the full message. Ignoring it for a few seconds causes the envelope to disappear, and then reappear after a fixed time interval.

In a second, silent mode of operation an icon of the software agent 28 blinks in the target application's main window caption bar, together with an envelope icon, signaling that a message is pending. Clicking on the blinking envelope icon opens the full message. Ignoring it for a few seconds causes the blink to stop, but the icon of the software agent 28 is altered to reflect the fact that there is a pending message. This is done to ensure the end-user 26 is made aware of the message, without annoying him with a constant blink.

Description of Computer Listing Appendices.

An exemplary client request protocol is given in Appendix “A”. Appendix “B” details an exemplary community protocol. Appendices “C” and “D” are portions of source code used in a preferred embodiment of the invention.

Alternate Embodiment.

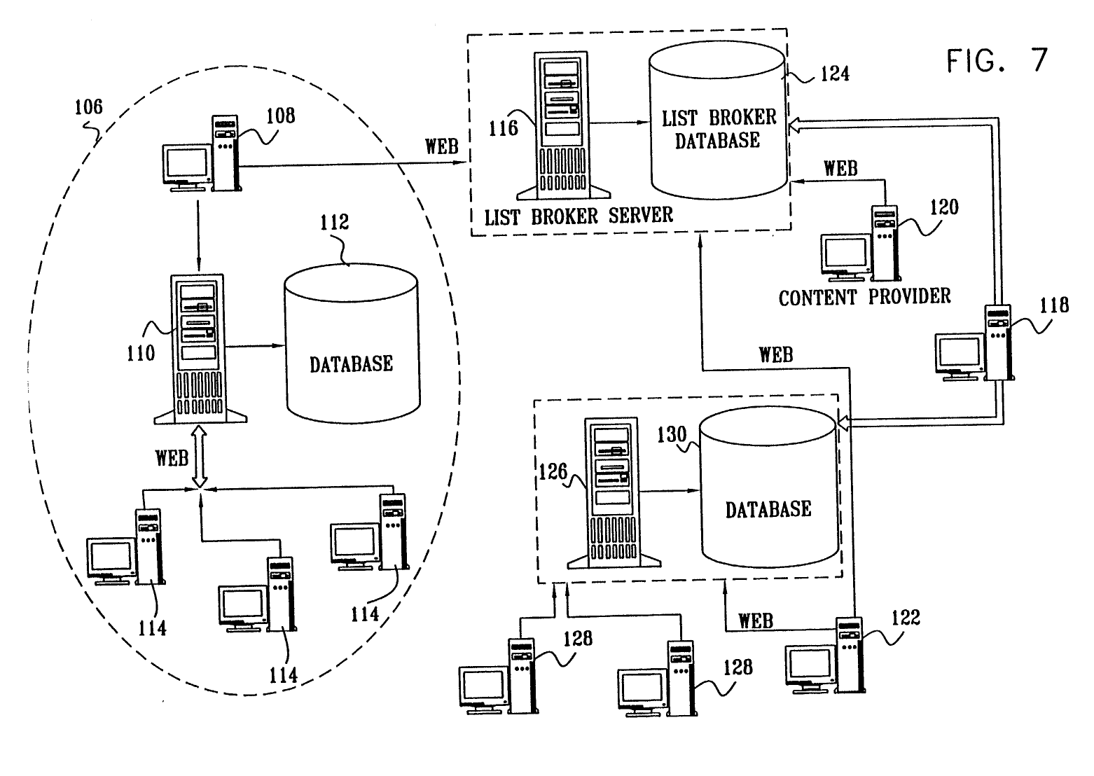

Turning now to FIG. 7, an alternate embodiment of the invention is shown, in which the server based manager 12 (FIG. 1) has an expanded function. A first system 106 is similar to the first embodiment illustrated in FIG. 1. Typically a proprietor 108 of a software application system controls an in-house server based manager 110, which hosts a database 112. The server based manager 110 and the database 112 function in the same way as the server based manager 12 and its associated database. The server based manager 110 communicates with a plurality of end-users 114 of the software application of the proprietor 108. As a consequence messages can be transmitted between the proprietor 108 and the end-users 114, as well as among the end-users 114 themselves. A second server based manager 116 is controlled by another entity 118. The entity 118 is preferably a broker of content providers. Representative end-users of the server based manager 116 are content provider 120, the proprietor 108, and a software vendor 122.

A database 124 of end-users is associated with the server based manager 116, and functions in the same way as the database of the server based manager 12 functions with respect to the user 16 and the user 22. The policies of the server based manager 116 are completely controlled by the entity 118.

Thus the content provider 120, having no end-users or clients of its own, but desiring to provide information to the end-users of the applications of the software vendor 122 or the proprietor 108 may arrange for the services of the server based manager 116, so that its content is delivered therethrough, reaching the proprietor 108 and the software vendor 122. The content is passed through the server based manager 110 and the server based manager 126 to the end-users 114 and the end-users 128, who at some points in time respectively execute the software applications of the proprietor 108 and the software vendor 122 and then receive notification of the content.

The software vendor 122 controls a server based manager 126 and its database 130, which functions in the same manner as the server based manager 12 and its database. However rather than being an in-house facility, the server based manager 126 may be a facility belonging to the entity 118. In some embodiments the server based manager 126 is physically resident in the entity 118, while in other embodiments it can be co-located with the software vendor 122. In some embodiments the entity 118 can exert varying degrees of influence on the policies of the server based manager 126.

Herein has been disclosed an invention which seamlessly integrates the power of the internet, facilitates end-user collaboration into any software application, builds marketing channels, end-user communities, and provides for content delivery automatically into existing software products.

While this invention has been explained with reference to the structure disclosed herein, it is not confined to the details set forth and this application is intended to cover any modifications and changes as may come within the scope of the following claims:

What is claimed is:

1. A computer software product, comprising a first computer-readable medium in which first computer program instructions are stored, which instructions, when read by a computer, cause said computer to perform the steps of:
determining a structure of a target software application;
responsive to said step of determining a structure, attaching an agent to said target software application at runtime, wherein said structure is unmodified by said agent;
establishing a first connection between said agent and a server via a data network;
receiving a first message from said server; and
presenting a first notification of said first message by said agent to a user in an environment of said target software application.

2. The software product according to claim 1, wherein said computer further performs the steps of:
establishing a second connection between said agent and a second agent of a second computer via said data network;
communicating a second message between said agent and said second agent via said data network; and
presenting a second notification of said second message by said agent to said user in said environment of said target software application.

3. The software product according to claim 1, wherein said agent comprises a plug-in of said target software application.

4. The software product according to claim 1, further comprising a second computer-readable medium in which second computer program instructions are stored, which instructions, when read by said server, cause said server to perform the step of transmitting said first message to said agent.

5. The software product according to claim 4 wherein said server further performs the step of authenticating an identity of said computer.

6. The software product according to claim 4, wherein said server further performs the steps of:
allowing controlled access to said server by a third computer, wherein said first message originates in said third computer, and is communicated to said server therefrom.

7. The software product according to claim 4, wherein said server further performs the step of receiving information from said agent via said data network indicative of an interaction of said user with said first message.

8. The software product according to claim 7; wherein said server further performs the step of storing a record of said interaction.

9. The software product according to claim 8, wherein said server further performs the step of maintaining a data base of users of said target software application.

10. The software product according to claim 1, wherein said agent accepts said first message according to a policy of said user.

11. A computer implemented method of communication, comprising the steps of:
establishing a connection between a user interface of a target software application that executes on a first computer and a second computer across a data network;
transmitting a message from said second computer to said first computer via said connection; and
notifying a user of said target software application of said message on said user interface.

12. The method according to claim 11, wherein said step of establishing said connection is performed by identifying a structure of said target software application.

13. The method according to claim 11, wherein a software agent is interposed in said connection.

14. The method according to claim 13, wherein said software agent executes on said first computer.

15. The method according to claim 13, wherein said software agent comprises a plug-in of said target software application.

16. The method according to claim 11, wherein said second computer comprises a server.

17. The method according to claim 11, wherein said second computer comprises an end-user computer.

18. A computer system comprising:
a computer;
a target software application resident in said computer;
a software agent that attaches to said target software application and controls a user interface of said target software application;
a connection to a data network;
wherein said software agent receives a first message that is transmitted from a second computer via said connection, and displays a notice of said first message on said user interface of said target software application.

19. The computer system according to claim 18, wherein said software agent is a plug-in to said target software application.

20. The computer system according to claim 18, wherein said software agent accepts said first message according to a policy of a user of said target software application.
